(19) United States
(12) Patent Application Publication
(10) Pub. No.: US 2009/0021603 A1
(43) Pub. Date: Jan. 22, 2009

(54) EXPOSURE ADJUSTMENT METHODS AND SYSTEMS

(75) Inventor: Wen-Hung HSIEH, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/171,600

(22) Filed: Jul. 11, 2008

(30) Foreign Application Priority Data
Jul. 17, 2007 (TW) 096125975

(51) Int. Cl. H04N 5/235; H04N 3/14

(52) U.S. Cl. 348/230.1; 348/296; 348/E05.034; 348/E05.079

(57) ABSTRACT

Exposure adjustment methods and systems are provided. First, image data including a plurality of pixels is obtained. A plurality of sample regions is set based on respective pixels. A parameter calculation is performed according to a plurality of specific pixels in the sample regions to obtain a plurality of groups of adjustment parameters. At least one of the pixels is performed with a parameter adjustment according to the adjustment parameters.

### CROSS REFERENCE TO RELATED APPLICATIONS

This Application claims priority of Taiwan Patent Application No. 096125975, filed on Jul. 17, 2007, the entirety of which is incorporated by reference herein.

### BACKGROUND OF THE INVENTION

1. Field of the Invention

The disclosure relates generally to exposure adjustment methods and systems, and, more particularly to systems and methods that perform exposure adjustments on image data.

2. Description of the Related Art

Digital cameras with image sensors such as a charge coupled device (CCD) or complementary metal oxide semiconductor (CMOS) have gradually replaced conventional film cameras. Digital cameras have become a commonplace, due to ease of review and processing of captured images in related devices such as computers.

Generally, for a digital camera photography process, image data is captured (photo is taken) after an environment light source is first detected, and appropriate exposure parameters are determined. In some specific environments, such as a high contrast environment or environment against light, a part of a photo taken therein may be overexposed or underexposed. Since the digital camera does not provide any mechanism to adjust the captured photos, users must download the photos to a computer system, and manually perform related operations using image processing software. Since users may not be capable of performing exposure adjustment and/or using the image processing software, the photography process and post-exposure adjustment for the above specific environments are often inconvenient for users.

### BRIEF SUMMARY OF THE INVENTION

Exposure adjustment methods and systems are provided.

In an embodiment of an exposure adjustment method, image data comprising a plurality of pixels is obtained. A plurality of sample regions is set based on respective pixels. A parameter calculation is performed according to a plurality of specific pixels in the sample regions to obtain a plurality of groups of adjustment parameters. At least one of the pixels is performed with a parameter adjustment according to the adjustment parameters.

An embodiment of an exposure adjustment system comprises image data and a processing unit. The image data comprises a plurality of pixels. The processing unit sets a plurality of sample regions based on respective pixels. The processing unit performs a parameter calculation according to a plurality of specific pixels in the sample regions to obtain a plurality of groups of adjustment parameters, and performs a parameter adjustment to at least one of the pixels according to the adjustment parameters.

An embodiment of an exposure adjustment system comprises an image capture system, a processing unit, and a storage unit. The image capture system captures a first image. The first image comprises a plurality of pixels. The processing unit sets a plurality of sample regions based on respective pixels of the first image. The processing unit performs a parameter calculation according to a plurality of specific pixel parameters in the sample regions to obtain a plurality of groups of adjustment parameters, and adjusts a pixel parameter of at least one of the pixels using the adjustment parameters to obtain a second image. The processing unit drives the storage unit to store the second image.

Exposure adjustment methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an exposure adjustment system;

FIG. 2 is a flowchart of an embodiment of an exposure adjustment method;

FIG. 3 is a schematic diagram illustrating an embodiment of a relationship between an adjusted pixel in image data and a specific range;

FIG. 4 is a flowchart of an embodiment of an exposure adjustment method; and

FIG. 5 is a schematic diagram illustrating an embodiment of a plurality of sample regions of a specific range.

### DETAILED DESCRIPTION OF THE INVENTION

Exposure adjustment methods and systems are provided.

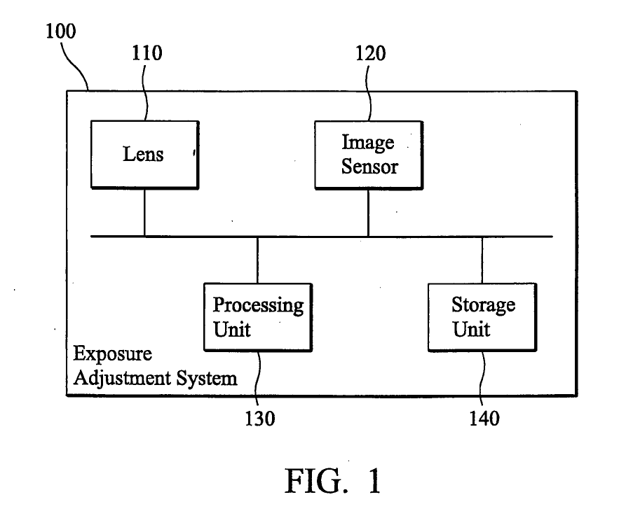

FIG. 1 is a schematic diagram illustrating an embodiment of an exposure adjustment system.

The exposure adjustment system 100 may be a processor-based electronic device, such as a computer system, a digital camera, and others. When the exposure adjustment system 100 is a digital camera, the exposure adjustment system 100 comprises a lens 110, an image sensor 120, a processing unit 130, and a storage unit 140. The image sensor 120 may be a CCD or CMOS. During a photography process, the processing unit 130 can control the diaphragm and shutter of the lens 110, and the exposure time of the image sensor 120 to obtain image data (photos) from the image sensor 120. The processing unit 130 performs the exposure adjustment of the application to the image data, and stores the adjusted image data to the storage unit 140. The storage unit 140 may be a built-in memory of the digital camera or an external memory card. It is noted that, when the exposure adjustment system 100 is a computer system, the exposure adjustment system 100 does not comprise the lens 110 and the image sensor 120. The image data can be directly stored in the storage unit 140, and the processing unit 130 can perform the exposure adjustment of the application to the image data.

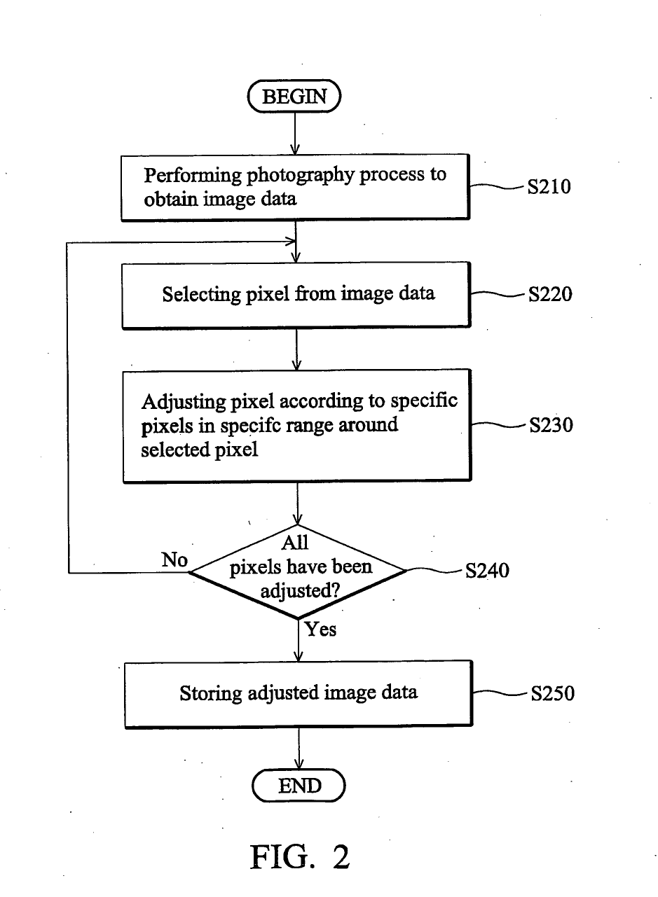

FIG. 2 is a flowchart of an embodiment of an exposure adjustment method.

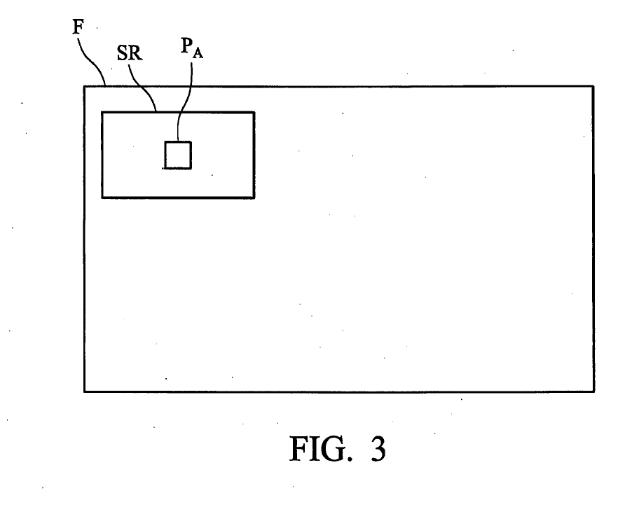

In step S210, a photography process is performed, such that the processing unit 130 obtains image data via the lens 110 and the image sensor 120. The image data comprises a plurality of pixels. In step S220, one of the pixels is selected from the image data, wherein an exposure adjustment will be performed on the selected pixel. In some embodiments, exposure adjustment of the pixels in the image data can be performed in sequence, such as from left to right and from top to bottom. In step S230, an exposure adjustment is performed on the selected pixel according to pixel values of specific pixels in a specific range around the selected pixel. FIG. 3 is a schematic diagram illustrating an embodiment of a relationship between an adjusted pixel in image data and a specific range. As shown in FIG. 3, the specific range SR in the image data F is located around the adjusted pixel PA. In some embodiments, the size of the specific range can be determined according to the maximum pixels that can be detected by the image sensor 120. For example, when the maximum pixels that can be detected by the image sensor 120 is 3264×2448, the size of the specific range can be set as 320×240. That is, the size of the specific range substantially equals to 1/100 of that of the image data. It is understood that the size and shape of the specific range can be determined according to various requirements, and is not limited thereto. During the exposure adjustment, a parameter calculation is performed according to the pixel values of the specific pixels to obtain at least one adjustment parameter, and a pixel parameter adjustment is performed on the selected pixel according to the adjustment parameter. Then, in step S240, it is determined whether the exposure adjustment have been performed on all of the pixels in the image data If not (No in step S240), the procedure returns to step S220, to select another pixel to be adjusted. If so (Yes in step S240), in step S250, the adjusted image data is stored to the storage unit 140.

It is understood that, as described, the exposure adjustment system 100 of the application may be a computer system or a digital camera. When the exposure adjustment system 100 is a computer system, the processing unit 130 of the exposure adjustment system 100 can directly perform the operations from steps S220 to S250 in FIG. 2 to the image data.

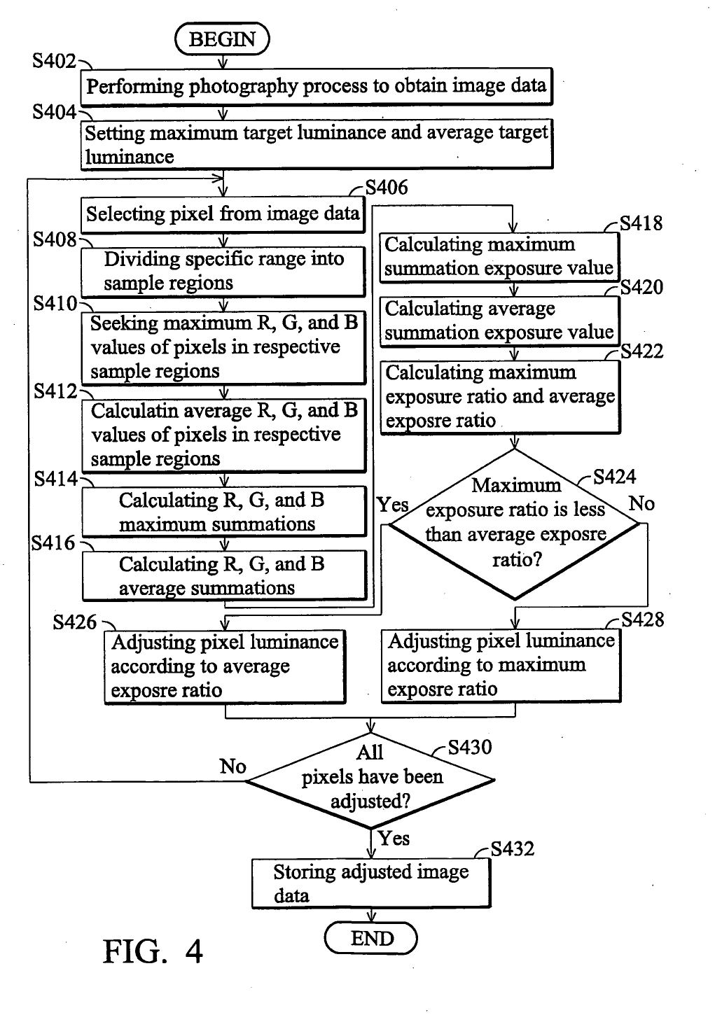

FIG. 4 is a flowchart of an embodiment of an exposure adjustment method. In this embodiment, a maximum exposure ratio and an average exposure ratio can be calculated according to the pixel values of the specific pixels in the specific range, and a selected pixel can be adjusted according to the maximum exposure ratio and the average exposure ratio.

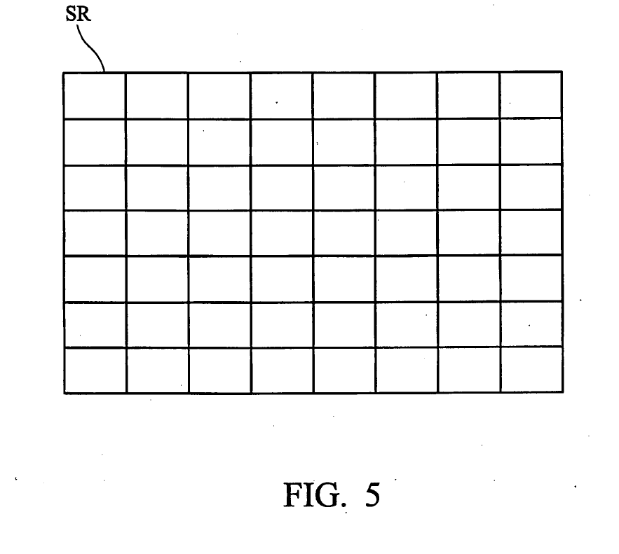

In step S402, a photography process is performed, such that the processing unit 130 obtains image data via the lens 110 and the image sensor 120. The image data comprises a plurality of pixels. In step S404, a maximum target luminance and an average target luminance are set. It is noted that the maximum target luminance and the average target luminance can be set according to various requirements and applications. In step S406, one of the pixels is selected from the image data, wherein an exposure adjustment is to be performed on the selected pixel. Similarly, in some embodiments, exposure adjustment on the pixels in the image data can be performed in sequence, such as from left to right and from top to bottom. In step S408, a specific range around the selected pixel is divided into a plurality of sample regions. For example, in FIG. 5, the specific range is divided into 56 sample regions. Similarly, the size and shape of the specific range can be determined according to various requirements. Then, in step S410, the maximum R, G, and B values of the pixels in the respective sample regions are sought. It is noted that each pixel is composed of R, G, and B values. The maximum R, G, and B values of the pixels the for the respective sample regions are labeled as rMax₁, rMax₂, . . . , rMax₅₆, gMax₁, gMax₂, . . . , gMax₅₆, bMax₁, bMax₂, . . . , and bMax₅₆. In step S412, the average R, G, and B values of the pixels in the respective sample regions are calculated, and labeled as rAvg₁, rAvg₂, . . . , rAvg₅₆, gAvg₁, gAvg₂, . . . , gAvg₅₆, bAvg₁, bAvg₂, . . . , and bAvg₅₆. In step S414, the maximum R, G, and B values of the pixels for the respective sample regions are respectively multiplied by a weight (wᵢ) corresponding to the respective sample region, and added to obtain an R maximum summation (rSumMax), a G maximum summation (gSumMax), and a B maximum summation (bSumMax), wherein rSumMax=rMax₁×w₁+rMax₂×w₂+ . . . +rMax₅₆×w₅₆, gSumMax=gMax₁×w₁+gMax₂×w₂+ . . . +gMax₅₆×w₅₆, and bSumMax=bMax₁×w₁+bMax₂×w₂+ . . . +bMax₅₆×w₅₆. Then, in step S416, the average R, G, and B values of the pixels for the respective sample regions are respectively multiplied by the weight corresponding to the respective sample region, and added to obtain an R average summation (rSumAvg), a G average summation (gSumAvg), and a B average summation (bSumAvg), wherein rSumAvg=rAvg₁×w₁+rAvg₂×w₂+ . . . +rAvg₅₆×w₅₆, gSumAvg gAvg₁×w₁+gAvg₂×w₂+ . . . +gAvg₅₆×w₅₆, and bSumAvg=bAvg₁×w₁+bAvg₂×w₂+ . . . +bAvg₅₆×w₁. In step S418, the maximum value among the rSumMax, gSumMax and bSumMax is divided by the total weight (wₘₐₓ) to obtain a maximum summation exposure value (maxSumAe), wherein maxSumAe=MAX(rSumMax, gSumMax, and bSumMax)/wₘₐₓ. In step S420, the maximum value among the rSumAvg, gSumAvg and bSumAvg is divided by the total weight (wₘₐₓ) to obtain an average summation exposure value (aveSumAe), wherein avgSumAe=MAX(rSumAvg, gSumAvg, and bSumAvg)/wₘₐₓ. Then, in step S422, a maximum exposure ratio and an average exposure ratio are respectively calculated according to maxSumAe and avgSumAe, wherein the maximum exposure ratio=maximum target luminance/maxSumAe, and is labeled as maxRatio, and the average exposure ratio=average target luminance/avgSumAe, and is labeled as avgRatio.

In step S424, it is determined whether maxRatio is less than avgRatio. If so (Yes in step S424), in step S426, the luminance of the selected pixel is adjusted according to avgRatio. If not (No in step S424), in step S428, the luminance of the selected pixel is adjusted according to maxRatio. Then, in step S430, it is determined whether the exposure adjustment has been performed on all of the pixels in the image data. If not (No in step S430), the procedure returns to step S406, to select another pixel to be adjusted. If so (Yes in step S430), in step S432, the adjusted image data is stored to the storage unit 140. Similarly, the exposure adjustment system 100 of the application may be a computer system or a digital camera. When the exposure adjustment system 100 is a computer system, the processing unit 130 of the exposure adjustment system 100 can directly perform the operations from steps S404 to S432 in FIG. 4 to the image data.

It is noted that when the selected pixel is located at the border of the image data, the specific range may go beyond the border of the image data, such that some invalid pixels may exist in the sample regions that go beyond the border of the image data. In this case, only valid pixels are considered, that is, the weights for the sample regions that go beyond the border of the image data are set as 0.

It is understood that any manner can be used to perform the exposure adjustment to the pixels based on the specific pixels in the specific range. FIG. 4 is only one embodiment of the application, and the application is not limited thereto. For example, in some embodiments, absolute difference values (absolute values of luminance) corresponding to R, G and B values of the respective two adjacent pixels in the respective sample regions can be calculated, and a contrast value is determined according to the distribution of the absolute difference values. The contrast value can be used to adjust the luminance of the pixels.

Exposure adjustment methods and systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An exposure adjustment method, comprising:
obtaining image data comprising a plurality of pixels;
setting a plurality of sample regions based on the respective pixels;
performing a parameter calculation according to a plurality of specific pixels in the sample regions to obtain a plurality of groups of adjustment parameters; and
performing a parameter adjustment to at least one of the pixels according to the adjustment parameters.

2. The method of claim 1, wherein the sample regions are respectively selected around the selected pixel.

3. The method of claim 1, wherein the sample regions are located in a specific range around the selected pixel.

4. The method of claim 3, wherein the size of specific range is 1/100 of that of the image data.

5. The method of claim 1, wherein each of the specific pixels in the respective sample region is composed of a first pixel value, a second pixel value, and a third pixel value.

6. The method of claim 5, further comprising:
seeking maximum values corresponding to the first, second and third pixel values from the specific pixels in the respective sample region;
calculating average values corresponding to the first, second and third pixel values of the specific pixels in the respective sample region;
calculating a first maximum summation value, a second maximum summation value, and a third maximum summation value according to the maximum values corresponding to the first, second and third pixel values;
calculating a first average summation value, a second average summation value, and a third average summation value according to the average values corresponding to the first, second and third pixel values;
calculating a maximum summation exposure value according to a maximum value among the first maximum summation value, the second maximum summation value, and the third maximum summation value;
calculating an average summation exposure value according to a maximum value among the first average summation value, the second average summation value, and the third average summation value;
calculating a maximum exposure ratio and an average exposure ratio according to the maximum summation exposure value, the average summation exposure value, a maximum target luminance, and an average target luminance; and
performing the exposure adjustment to the selected pixel according to the maximum exposure ratio and the average exposure ratio.

7. The method of claim 6, further comprising:
determining whether the maximum exposure ratio is less than the average exposure ratio;
if the maximum exposure ratio is less than the average exposure ratio, performing the exposure adjustment to the selected pixel according to the average exposure ratio; and
if the maximum exposure ratio is not less than the average exposure ratio, performing the exposure adjustment to the selected pixel according to the maximum exposure ratio.

8. The method of claim 5, wherein the adjustment parameters are obtained according to absolute differences corresponding to the first, second and third pixel values of two adjacent pixels in the respective sample regions.

9. The method of claim 5, wherein the first, second and third pixel values are R (red), G (green) and B (blue) values, respectively.

10. An exposure adjustment system, comprising:
image data comprising a plurality of pixels; and
a processing unit, setting a plurality of sample regions based on the respective pixels, performing a parameter calculation according to a plurality of specific pixels in the sample regions to obtain a plurality of groups of adjustment parameters, and performing a parameter adjustment to at least one of the pixels according to the adjustment parameters.

11. The system of claim 10, wherein the sample regions are located in a specific range around the selected pixel.

12. The system of claim 11, wherein the processing unit further divides the specific range into the sample regions, and each of the specific pixels in the respective sample region is composed of a first pixel value, a second pixel value, and a third pixel value.

13. The system of claim 12, wherein the processing unit further seeks maximum values corresponding to the first, second and third pixel values from the specific pixels in the respective sample region, calculates average values corresponding to the first, second and third pixel values of the specific pixels in the respective sample region, calculates a first maximum summation value, a second maximum summation value, and a third maximum summation value according to the maximum values corresponding to the first, second and third pixel values, calculates a first average summation value, a second average summation value, and a third average summation value according to the average values corresponding to the first, second and third pixel values, calculates a maximum summation exposure value according to a maximum value among the first maximum summation value, the second maximum summation value, and the third maximum summation value, calculates an average summation exposure value according to a maximum value among the first average summation value, the second average summation value, and the third average summation value, calculates a maximum exposure ratio and an average exposure ratio according to the maximum summation exposure value, the average summation exposure value, a maximum target luminance, and an average target luminance, and performs the exposure adjustment to the selected pixel according to the maximum exposure ratio and the average exposure ratio.

14. The system of claim 13, wherein the processing unit further determines whether the maximum exposure ratio is less than the average exposure ratio, and if so, performs the exposure adjustment to the selected pixel according to the average exposure ratio, and if not, performs the exposure adjustment to the selected pixel according to the maximum exposure ratio.

15. The system of claim 12, wherein the adjustment parameters are obtained according to absolute differences corresponding to the first, second and third pixel values of two adjacent pixels in the respective sample regions.

16. An exposure adjustment system, comprising:
an image capture system, capturing a first image comprising a plurality of pixels; and
a processing unit, setting a plurality of sample regions based on respective pixels of the first image, performing a parameter calculation according to a plurality of specific pixel parameters in the sample regions to obtain a plurality of groups of adjustment parameters, and adjusting a pixel parameter of the pixels using the adjustment parameters to obtain a second image; and
a storage unit, storing the second image.

17. The system of claim 16, wherein each of the specific pixels of the first image is composed of a first pixel value, a second pixel value, and a third pixel value.

18. The system of claim 17, wherein the adjustment parameters are obtained according to maximum values corresponding to the first, second and third pixel values of the specific pixels in the respective sample regions.

19. The system of claim 17, wherein the adjustment parameters are obtained according to average values corresponding to the first, second and third pixel values of the specific pixels in the respective sample regions.

20. The system of claim 17, wherein the adjustment parameters are obtained according to absolute differences corresponding to the first, second and third pixel values of two adjacent pixels in the respective sample regions.
